(19) United States
(12) Patent Application Publication
(10) Pub. No.: US 2026/0236039 A1
(43) Pub. Date: Aug. 13, 2026

(54) MULTI-UAV COORDINATED CONTROL METHOD BASED ON DYNAMIC DIRECTED GRAPH COMMUNICATION STRUCTURE

(71) Applicant: TONGJI UNIVERSITY, Shanghai (CN)

(72) Inventors: Bin HE, Shanghai (CN); Jie CHEN, Shanghai (CN); Bin CHENG, Shanghai (CN); Zhuohui ZHANG, Shanghai (CN); Chenlong LIU, Shanghai (CN)

(73) Assignee: TONGJI UNIVERSITY, Shanghai (CN)

(21) Appl. No.: 19/393,666

(22) Filed: Nov. 19, 2025

(30) Foreign Application Priority Data
Feb. 7, 2025 (CN) 2025101368860

(51) Int. Cl. G05D 1/69; G05D 101/15; G05D 109/20; G05D 111/30

(52) U.S. Cl. CPC G05D 1/69; G05D 2101/15; G05D 2109/20; G05D 2111/32

(57) ABSTRACT

The present invention discloses a multi-UAV coordinated control method based on a dynamic directed graph communication structure. In a distributed execution phase, based on local observation values and historical hidden states, a communication structure between UAVs is dynamically adjusted through a multi-key gated communication network using an adjacency trajectory matrix. Local action value functions are calculated and the hidden states are updated based on an updated adjacency trajectory matrix and pre-communication information, and a final control decision is generated and executed. In a centralized training phase, the adjacency trajectory matrix and the local observation value at each moment are recorded to generate a global state, and a global action value function is generated using a mixing network, and network parameters are then updated through rewards. A trained graph collapse network and the mixing network are deployed to each UAV to achieve distributed execution.

### FIELD OF THE INVENTION

The present disclosure belongs to the field of multi-UAV cooperative control technology, in particular to a multi-UAV coordinated control method based on a dynamic directed graph communication structure.

### BACKGROUND OF THE INVENTION

In recent years, cooperative multi-UAV reinforcement learning technology has emerged as a significant framework for addressing complex collaborative tasks in real-world scenarios, attracting substantial attention and demonstrating considerable potential in both practical applications and commercial domains. Centralized collaborative multi-agent reinforcement learning (MARL) approaches treat the multi-UAV system as a unified entity and employ single-agent methods to learn a collective policy. However, such methods face challenges related to limited scalability and the constraints of relying on a central controller. Decentralized collaborative MARL approaches, on the other hand, treat each UAV as an individual entity and utilize single-agent techniques to learn individual policies. While this decentralized collaborative MARL approach resolves the dependency on a central controller, it introduces non-stationarity and credit assignment issues. To address these challenges, existing multi-UAV reinforcement learning algorithms primarily adopt the Centralized training with decentralized execution (CTDE) paradigm. This paradigm relies on access to global state—an assumption that is often idealized and impractical in real-world settings, where a central trainer is generally unavailable. In contrast, research focusing on communication between UAVs holds greater practical significance.

In the multi-UAV system, communication is particularly crucial for information sharing, learning, and collaboration to achieve common goals, especially in partially observable environments. For complex tasks such as coordinating autonomous vehicles, sensor networks, and multi-robot systems, effective communication serves as the foundation for cooperation. Inspired by the ways humans collaborate, researchers have integrated communication into multi-UAV reinforcement learning to enhance the capability of information sharing among UAVs. Early research efforts primarily relied on broadcasting to disseminate information, but this approach resulted in high communication costs and information redundancy. Subsequent studies aimed to reduce communication overhead by selectively determining the timing of communication and eliminating redundant information through targeted peer-to-peer communication. However, existing methods typically model communication individually for each UAV, which lacks scalability when the count of UAVs changes. There remains a lack of methods capable of addressing five key communication challenges: how to determine the communication recipients, the timing of communication, the content of communication, how to integrate received information, and how to utilize communication to avoid reliance on global state information.

### SUMMARY OF THE INVENTION

The present disclosure provides a multi-UAV coordinated control method based on a dynamic directed graph communication structure.

The objective of the present disclosure can be achieved through the following technical solutions:

In one aspect, the present disclosure provides a multi-UAV coordinated control method based on a dynamic directed graph communication structure, comprising:
UAVs obtaining local observation values of an environment and obtaining historical hidden states from other UAVs through communication;
in a distributed execution phase, obtaining a current adjacency trajectory matrix representing a communication relationship between UAVs at a current moment based on an initial topology of the UAVs, calculating pre-communication information based on the local observation values and the historical hidden states, inputting the current adjacency trajectory matrix and the pre-communication information into a multi-key gated communication network to calculate an adjacency trajectory matrix at a next moment, each UAV calculating its local action value function based on the pre-communication information and the adjacency trajectory matrix at the next moment through a Transformer-based decoder and updating its hidden state, generating and executing a final control decision based on the local action value function and the local observation value through a graph collapse network and a mixing network, and then proceeding to a next loop;
in a centralized training phase, recording the adjacency trajectory matrix at each moment of the distributed execution phase, inputting the local observation value and the adjacency trajectory matrix at each moment into the graph collapse network to generate a global state at each moment, generating a global action value function at each moment based on the global state at each moment and the local action value function of each UAV at each moment, a UAV swarm interacting with the environment and obtaining rewards based on the global action value function, and updating parameters of the mixing network based on the rewards through a first loss function;
after centralized training is completed, deploying a trained graph collapse network and the mixing network to each UAV

In some embodiments, the adjacency trajectory matrix represents a multi-UAV communication structure, the adjacency trajectory matrix is a Boolean matrix, and a value of a matrix element indicates whether there is communication between the UAVs.

In some embodiments, the calculating pre-communication information based on the local observation values and the historical hidden states includes:

converting the local observation values and the historical hidden states into pre-communication information C₀ using an encoding network MLP:

$${C}_{0} = MLP ( {o}_{t}^{i} , {h}_{t - 1}^{i} )$$

where C₀ represents the pre-communication information,

$${O}_{t}^{i}$$

represents the local observation values, and

$${h}_{t - 1}^{i}$$

represents the historical hidden states.

In some embodiments, the inputting the current adjacency trajectory matrix and the pre-communication information into a multi-key gated communication network to calculate an adjacency trajectory matrix at a next moment includes:
inputting a current adjacency trajectory matrix Aₜ and pre-communication information C₀ into the multi-key gated communication network for processing, wherein a calculation formula for the multi-key gated communication network is as follows:

$${K}_{0} = gumbel - softmax ( {w}_{v}^{T} tanh ( {W}_{q} ( {A}_{0} \times {C}_{0} ) + {W}_{k} ( {A}_{0} \times {C}_{0} ) ) )$$

where K₀ is a key output, A₀ represents an updated adjacency trajectory matrix in this communication; gumbel-softmax is a discrete sampling technique used to sample from discrete communication structures to determine whether each pair of UAVs communicates; Wᵥ represents a linear layer weight of an output dimension used to generate a final communication determination; tan h represents an activation function; C₀ represents the pre-communication information; W_{q} represents a query weight; and Wₖ represents a key weight;
after processing through the multi-key gated communication network, obtaining a total of i keys at a moment t, denoted as k_{t|i}, wherein the adjacency trajectory matrix at the next moment is represented as:

$${A}_{t + 1} = ⌈ {max}_{i} {k}_{t \vert i} ⌉$$

where [⋅] represents rounding up, and Aₜ₊₁ represents the adjacent trajectory matrix at the next moment.

In some embodiments, the each UAV calculating its local action value function based on the pre-communication information and the adjacency trajectory matrix at the next moment through a Transformer-based decoder and updating its hidden state includes:
repeatedly processing the pre-communication information by a multilayer perceptron (MLP) and then inputting into the Transformer-based decoder with the adjacency trajectory matrix at the next moment, the Transformer-based decoder including a self-attention mechanism, a position feedforward network, residual connection, and a normalization layer, input information being processed by a multi-head attention mechanism, residual connection and normalization, a point-by-point feedforward neural network, and residual connection and normalization, and adding processed information to the pre-communication information to obtain an updated hidden state

$${h}_{t}^{i}$$

and a local action value function Qⁱ(s, a) of a UAV i through a fully connected layer.

In some embodiments, the graph collapse network includes a graph convolutional network, a self-attention pooling network, and a readout mechanism.

In some embodiments, the generating a global state includes:
using the local observation value

$${O}_{t}^{i}$$

of each UAV as a feature input to each node in the graph convolutional network for feature extraction and node learning representation, as shown in the formula:

$${\tilde{X}}_{t}^{i} = σ ( {\tilde{D}}_{t + 1}^{{i}^{- \frac{1}{2}}} {A}_{t + 1}^{i} {\tilde{D}}_{t + 1}^{{i}^{- \frac{1}{2}}} {o}_{t}^{i} )$$

where

$${O}_{t}^{i}$$

represents the local observation value of the UAV i at the moment t,

$${\tilde{X}}_{t}^{i}$$

represents node representation,

$${A}_{t + 1}^{i}$$

represents a value of an i-th node in the adjacency trajectory matrix at the next moment,

$${\tilde{D}}_{t + 1}^{i}$$

represents a degrees matrix of the i-th UAV at a moment t+1, and σ represents a nonlinear activation function;
inputting learned node representation

$${\tilde{X}}_{t}^{i}$$

into the self-attention pooling network, the self-attention pooling network selecting important nodes in the graph through feature weighting and node importance evaluation, and then weighting features of the important nodes to output feature weighted nodes of the graph, as shown in the formula:

$${X}_{t}^{{i}^{′}} = concat ( {\tilde{X}}_{t}^{i} ) ⊙ tanh ( {\tilde{D}}_{t + 1}^{{i}^{- \frac{1}{2}}} {A}_{t + 1}^{i} {\tilde{D}}_{t + 1}^{{i}^{- \frac{1}{2}}} concat ( {\tilde{X}}_{t}^{i} ) )$$

where

$${X}_{t}^{{i}^{′}}$$

represents weighted feature node representation of a node i, concat represents a feature fusion method, tanh represents an activation function, and ⊙ represents element-wise multiplication;
aggregating the weighted feature node representation of each node through a readout mechanism to generate a global state sₜ, as shown in the formula:

$${s}_{t} = \frac{1}{N} {\sum }_{i = 1}^{n} {X}_{t}^{{i}^{′}} ‖ \begin{matrix}n \\ max \\ i = 1\end{matrix} {X}_{t}^{{i}^{′}}$$

where N represents a count of nodes, max represents an aggregation function, and i and n represent positive integers.

In some embodiments, the generating a global action value function at each moment based on the global state at each moment and the local action value function of each UAV at each moment includes:
inputting a global state sₜ and a local action value function Qⁱ(s, a) of each UAV into the mixing network, a UAV swarm learning a mixing network Qₜₒₜ(τ, a, Am, s; θ) and using a QMIX network to determine a weight of each local action value function using the global state, and then weighting the local action value function of each UAV to synthesize a global action value function Qₜₒₜ(s, a).

In some embodiments, the first loss function is represented as:

$${ℒ}_{1} = {\sum }_{i = 1}^{b} [ {( {y}_{i}^{tot} - {Q}_{tot} ( {τ}_{t} , {α}_{t} , {m}_{t} , {s}_{t} ; θ ) )}^{2} ]$$

$${y}_{i}^{tot} = r + γ {max}_{{a}_{t + 1}} {Q}_{tot} ( {τ}_{t + 1} , {α}_{t + 1} , {m}_{t + 1} , {s}_{t + 1} ; {θ}^{-} )$$

where [symbol] represents the first loss function, b is a batch size, representing a count of samples sampled from a replay buffer,

$${y}_{i}^{tot}$$

represents a target Q value of the UAV i, Qₜₒₜ(τₜ, αₜ, mₜ, sₜ; θ) represents a mixing network Q value at a moment t, τₜ represents a historical observation value at the moment t, αₜ represents an action at the moment t, mₜ represents information of the UAV swarm at the moment t, sₜ represents the global state at the moment t, θ represents a parameter of the mixing network, r represents a reward obtained by the UAV swarm interacting with the environment, γ represents a discount factor, and max_{α}_{ₜ₊₁} represents a maximum Qₜₒₜ value of an action αₜ₊₁.

In some embodiments, the distributed execution phase and the centralized training phase are bridged through the adjacency trajectory matrix.

Compared with the existing technologies, the present disclosure has the following advantages:

(1) A novel communication cooperated multi-UAV reinforcement learning paradigm is implemented, addressing scalability issues when the count of UAVs changes: the multi-UAV system is modeled as a dynamic directed graph that effectively represents the communication structure at any moment. By employing a graph collapse network to bridge training and execution phases with synchronized communication, the method eliminates the need for individual agent modeling in traditional approaches, thereby significantly enhancing the scalability.

(2) The present disclosure achieves global state information aggregation by leveraging the topological structure of dynamic directed graphs, thereby reducing the dependency of the system on comprehensive global states. For the multi-UAV system, the multi-key gated communication network is designed to learn the structure of dynamic directed graphs during the distributed execution phase, integrated with the Transformer-based decoder to enable communication and feature extraction. The dynamic graph structure learned by the multi-key gated communication network is fed into the graph collapse network during the centralized training phase, performing information aggregation to generate approximated global state information.

(3) The present disclosure dynamically adjusts the adjacency trajectory matrix among UAVs through the multi-key gated communication network, enabling the UAV swarm to flexibly adapt its communication structure in complex environments, thereby enhancing the efficiency and reliability of information transmission. Compared with communication methods with fixed topological structures, the method can adapt to diverse mission requirements and achieve more efficient cooperative control.

(4) The present disclosure employs the Transformer-based decoder to process the local observation values and communication information of UAVs. By leveraging the self-attention mechanism, it significantly enhances information interaction capabilities, improves the decision-making accuracy of each UAV, and avoids decision errors caused by insufficient local information in traditional methods.

(5) The present disclosure extracts the overall features of the UAV swarm through a graph convolutional network (GCN) and a self-attention pooling network, and employs a readout mechanism to aggregate information from individual UAVs, thereby generating an accurate global state. The method effectively mitigates noise interference, enhances the representation capacity of global information, and strengthens the collaborative perception capability of the UAV swarm.

(6) The present disclosure employs a QMIX mixing network to adaptively adjust the weight of the local action value function for each UAV based on the global state, thereby achieving globally optimal decision-making for the swarm. Compared with traditional independent Q-learning approaches, the method effectively addresses the non-stationarity problem in multi-agent reinforcement learning, leading to improved convergence speed and control accuracy.

(7) During the training phase, the parameters of the mixing network are optimized using centralized training, enabling the UAV swarm to learn the globally optimal policy. During the execution phase, each UAV relies solely on local computation and limited communication to make independent decisions, thereby achieving efficient distributed execution. The method reduces communication overhead and enhances the robustness and real-time performance of the system.

### BRIEF DESCRIPTION OF DRAWINGS

FIG. 1 is a schematic diagram showing overall modules in the present disclosure;

FIG. 2 is a schematic diagram showing a graph collapse network module;

FIG. 3 is a schematic diagram showing a system relationship between a graph collapse network module and a method;

FIG. 4 is a flowchart showing an exemplary multi-UAV reinforcement learning method based on a dynamic directed graph communication structure.

### DETAILED DESCRIPTION

The technical solutions of the embodiments of the present disclosure will be clearly and completely described below with reference to the accompanying drawings. Obviously, the described embodiments are only some embodiments of the present disclosure, not all embodiments. Based on the embodiments of the present disclosure, all other embodiments obtained by those skilled in the art without creative effort should fall within the scope of the present disclosure.

### Embodiment 1

In one aspect, the present disclosure provides a multi-UAV reinforcement learning method based on a dynamic directed graph communication structure, applied to multi-UAV collaboration. The method specifically includes the following steps:

Step S1: UAVs obtaining local observation values (or, LOVs) of an environment and obtaining historical hidden states from other UAVs through communication. The local observation value

$${O}_{t}^{i}$$

refers to State Information obtained from the environment at a current moment (moment t) by each UAV. The information includes environmental features and its own state perceived by the UAV, such as position, speed, attitude, surrounding obstacles, target position, etc. The local observation values are usually obtained directly from sensors (e.g., vision, radar, lidar, etc.) when each UAV performs a task, and only reflect the local environment around the UAV; the historical hidden state refers to the representation of an internal state of each UAV at a past moment (moment t−1). It contains information such as the UAV's decision-making process over a period of time, observed environmental information, actions performed, and communication history with other UAVs. The historical hidden state is used to save and transmit important memories of the UAV during the mission execution process for reference in future decisions. The historical hidden state encodes the UAV's observations (local observation values) of the environment at past moments and the decisions made based on the observations. The historical hidden state records the changes in the UAV's state over time, including dynamic information on how it changes during mission execution. The historical hidden state also includes interaction information between UAVs, communication information from other UAVs, and how to make coordinated decisions based on the information.

Step S2: In a distributed execution phase, obtaining a current adjacency trajectory matrix (or, CATM) representing a communication relationship between UAVs at a current moment based on an initial topology of the UAVs, calculating pre-communication information based on the local observation values and the historical hidden states, inputting the current adjacency trajectory matrix and the pre-communication information into a multi-key gated communication network to calculate an adjacency trajectory matrix at a next moment, each UAV calculating its local action value function based on the pre-communication information and the adjacency trajectory matrix at the next moment through a Transformer-based decoder and updating its hidden state, generating and executing a final control decision based on the local action value function and the local observation value through a graph collapse network and a mixing network, and then proceeding to a next loop.

Step S3: In a centralized training phase, recording the adjacency trajectory matrix at each moment of the distributed execution phase, inputting the local observation value and the adjacency trajectory matrix at each moment into the graph collapse network to generate a global state at each moment, generating a global action value function at each moment based on the global state at each moment and the local action value function of each UAV at each moment, a UAV swarm interacting with the environment and obtaining rewards based on the global action value function, and updating parameters of the mixing network based on the rewards through a first loss function.

Step S4: After centralized training is completed, deploying a trained graph collapse network and the mixing network to each UAV.

As a preferred technical solution, the multi-UAV system is modeled as a dynamic directed graph. Furthermore, each UAV serves as a node in the graph, and the adjacency trajectory matrix Aₜ represents the communication structure of the system. Specifically, Aₜ represents a Boolean matrix, and a value of a matrix element indicates whether there is communication between the UAVs.

As a preferred technical solution, the Transformer-based graph collapse network consists of a graph collapse network and a Transformer-based multi-key gated communication network. Furthermore, the graph collapse network includes a graph convolutional network, a self-attention pooling network, and a readout mechanism; the Transformer-based multi-key gated communication network includes an encoder based on a dynamic directed graph and a Transformer-based decoder, following an encoder-decoder architecture.

As a preferred technical solution, the local observation value is provided by the UAV. Specifically, at each time step t, each UAV receives a local observation value from the observation value function.

As a preferred technical solution, the process of obtaining the adjacency trajectory matrix and fusion information specifically includes initializing and preprocessing the local observation values and historical information (or, HI); performing pre-communication based on the adjacency trajectory matrix of the previous time step and the hidden information of the UAV in the previous time step and obtaining the pre-communication information; and processing the pre-communication information and the initialized adjacency trajectory matrix using a multi-key gated communication network to obtain an adjacency trajectory matrix of a next time step and fusion information.

As a preferred technical solution, the Transformer-based decoder consists of four parts, specifically including a self-attention mechanism, a position feedforward network, residual connection, and a normalization layer.

As a preferred technical solution, the process of generating the local action value function and the hidden information specifically includes inputting the adjacency trajectory matrix and the fusion information output by the multi-key gated communication network into a Transformer-based decoder; and obtaining the local action value function and the hidden information of the next time step using the output of the Transformer-based decoder.

As a preferred technical solution, the process of obtaining the global action value function specifically includes: inputting the local action value function and the adjacency trajectory matrix into the graph collapse network; normalizing the adjacency trajectory matrix; then using the local observation values as feature inputs for each node in the graph convolutional network to perform graph convolution iteration; furthermore, performing self-attention pooling based on graph convolution iteration results; generating an approximate global state function by performing aggregation operations on all nodes; and finally outputting the global action value function through a mixing network based on the approximate global state function.

As a preferred technical solution, there is a connection between the distributed execution phase and the centralized training phase, specifically, the distributed execution phase and the centralized training phase are bridged through a dynamic directed graph.

In another aspect, the present disclosure provides a novel readout mechanism, specifically, performing an aggregation operation on all nodes to generate a global collapse representation of the graph, which approximates the global state.

The present disclosure designs a method for the multi-UAV system that simultaneously includes communication, information extraction, and decision-making functions, supports the multi-UAV system with dynamic adjustment of the count of UAVs, and provides support for the collaborative control of the multi-UAV system and the enhancement of communication and decision-making among UAVs.

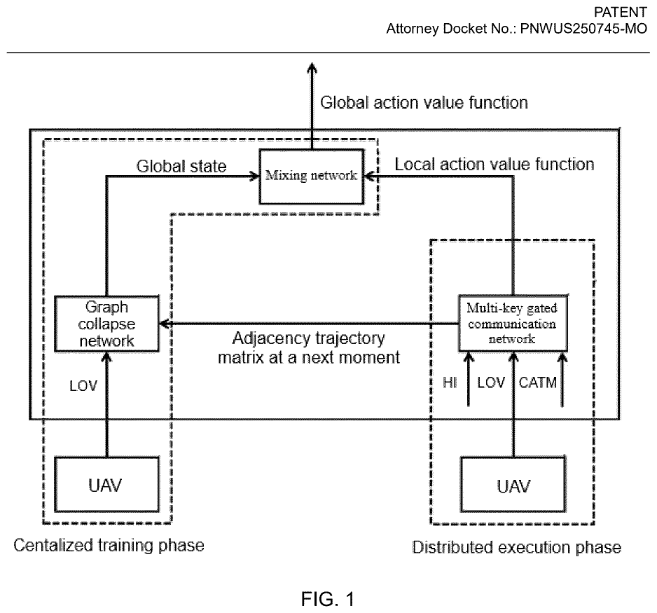

As shown in FIG. 1, the overall system model of Embodiment 1 includes a multi-key gated communication network, a graph collapse network, and a mixing network. The multi-key gated communication network and the graph collapse network are connected to the UAV.

The multi-key gated communication network is configured to receive a local historical information and an adjacency trajectory matrix Aₜ observation value

$${O}_{t}^{i} ,$$

historical information

$${h}_{t - 1}^{i} ,$$

and an adjacency trajectory matrix Aₜ at a current moment from the UAV through the communication part of the network. In the distributed execution phase, the multi-key gated communication network generates an adjacency trajectory matrix Aₜ₊₁ at a next moment, a local action value function Qⁱ, and hidden information

$${h}_{t}^{i} ,$$

and inputs the local action value function and the local observation value into the graph collapse network. The multi-key gated communication network is further configured to bridge centralized training and distributed execution through the adjacency trajectory matrix at the next moment. The input information of the multi-key gated communication network includes the local observation value, the historical information, and the adjacency trajectory matrix at the current moment. After initialization and preprocessing, the input information is pre-communicated, and the multi-key gated communication network processes the pre-communication information C₀ and the adjacency trajectory matrix A₀. A communication frequency between the UAVs is determined by a count of keys, and the output of each key represents the updated adjacency trajectory matrix in this communication. The specific calculation formula is shown in formula (1):

$${K}_{0} = gumbel - softmax ( {w}_{v}^{T} tanh ( {W}_{q} ( {A}_{0} \times {C}_{0} ) + {W}_{k} ( {A}_{0} \times {C}_{0} ) ) )$$

where K₀ represents a key output, A₀ represents the adjacency trajectory matrix, gumbel-softmax sampling is a technique of sampling from discrete distribution, wᵥ represents a linear layer for two output dimensions (communication or non-communication); tanh represents an activation function; C₀ represents the pre-communication information; W_{q} represents a query weight; and Wₖ represents a key weight. After processing through the multi-key gated communication network, a total of i keys can be obtained at the moment t, denoted as k_{t|i}. The adjacency trajectory matrix at the next moment is represented as shown in formula (2):

$${A}_{t + 1} = [ {max}_{i} {k}_{t \vert i ]} ]$$

where [⋅] represents rounding up, and Aₜ₊₁ represents the adjacent trajectory matrix at the next moment (moment t+1). The transmission and reception of information are accomplished by using the adjacency trajectory matrix updated at the next time step combined with the pre-communication information.

The graph collapse network is configured to aggregate all inputs during the centralized training phase using the local observation value

$${O}_{t}^{i}$$

of the UAV and the adjacency trajectory matrix Aₜ₊₁ at the next moment to generate a global collapse representation of the dynamic directed graph, which is approximately a global state function sₜ. An input of the graph collapse network includes the local observation value oₜ of each UAV and the adjacency trajectory matrix Aₜ₊₁ at the next moment. The input adjacency trajectory matrix is normalized, and the local observation value of the UAV is used as the input of the graph convolutional network. A result after three graph convolution iterations is input into the self-attention pooling network. The pooled result is aggregated through the readout mechanism to generate the global state, and the global state is input into the mixing network.

The mixing network is configured to aggregate the local action value function Qⁱ of each UAV to form a global action value function Qₜₒₜ, which guides the overall policy optimization of the multi-UAV system. An input of the mixing network is the local action value function of each UAV and the global state function st output by the graph collapse network, and an output of the mixing network is the global action value function, which evaluates the overall value of the multi-UAV system taking a certain cooperative action in a certain state. The mixing network can reflect the cooperative effect between UAVs and guide updating of UAV policy.

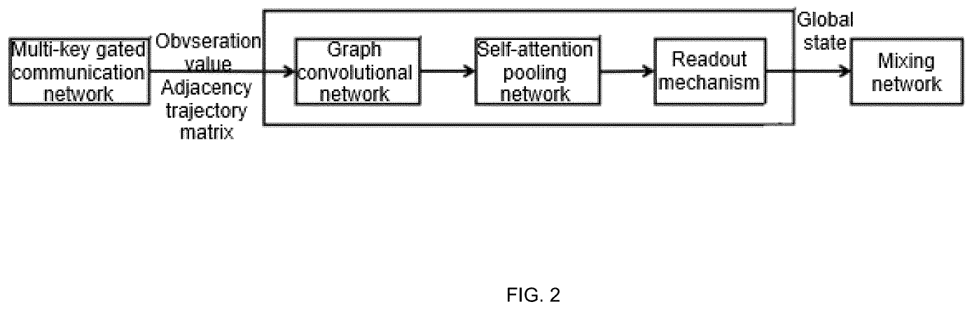

As shown FIG. 2, the graph collapse network module of the present disclosure includes a graph convolutional network, a self-attention pooling network and a readout mechanism. The readout mechanism is connected to the mixing network, and the graph convolutional network is connected to the multi-key gated communication network.

The graph convolutional network extracts features and learns node representations by using the local observation value oₜ of the UAV as the feature input of each node in the graph convolutional network, and inputs the learned node representations into the self-attention pooling network. An input of the convolutional network is the local observation, and an output of the convolutional network is the representations of all nodes in the graph. The specific network structure is shown in formula (3):

$${\tilde{X}}_{t}^{i} = σ ( {\tilde{D}}_{t + 1}^{{i}^{- \frac{1}{2}}} {A}_{t + 1}^{i} {\tilde{D}}_{t + 1}^{{i}^{- \frac{1}{2}}} {o}_{t}^{i} )$$

where

$${O}_{t}^{i}$$

represents the local observation value of the UAV i at the moment t,

$${\tilde{X}}_{t}^{i}$$

represents the node representation,

$${A}_{t + 1}^{i}$$

represents a value of an i-th node in the adjacency trajectory matrix at the next moment,

$${\tilde{D}}_{t + 1}^{i}$$

represents a degree matrix of the i-th UAV at a moment t+1, and σ represents a nonlinear activation function; the graph convolutional network is mainly responsible for feature extraction and information propagation in the data processing of the dynamic directed graph.

The function of the self-attention pooling network is to select important nodes in the graph through feature weighting and node importance evaluation, and weight features of the important nodes. The input is the representation of all nodes in the graph, and the output is the feature weighted nodes of the graph. The structure of the self-attention pooling network in present disclosure is shown in formula (4):

$${X}_{t}^{{i}^{′}} = c o n c a t ( {\tilde{X}}_{t}^{i} ) ⊙ tanh ( {\tilde{D}}_{t + 1}^{{i}^{- \frac{1}{2}}} {A}_{t + 1}^{i} {\tilde{D}}_{t + 1}^{{i}^{- \frac{1}{2}}} c o n c a t ( {\tilde{X}}_{t}^{i} ) )$$

where

$${X}_{t}^{{i}^{′}}$$

represents a weighted feature node of the graph,

$${\tilde{X}}_{t}^{i}$$

represents node representation, concat represents a feature fusion method, tan h represents an activation function,

$${A}_{t + 1}^{i}$$

is the self-loop adjacency matrix of the i-th node at the moment t+1, and

$${\tilde{D}}_{t + 1}^{i}$$

represents its degree matrix.

The readout mechanism aggregates all nodes to generate a global collapse representation of the graph and an approximate global state function. An input of the readout mechanism is all nodes in the graph, and an output of the readout mechanism is the global collapse representation of the graph. The readout mechanism uses a Mean aggregation function and a Max aggregation function to take average and maximum values of the nodes, respectively. The Mean aggregation function is used to smoothly integrate the information of all nodes and reduce the influence of noise. The Max aggregation function is used to highlight the significant features of specific nodes and retain the most important information in the graph. The expression of the readout mechanism is shown in formula (5):

$${s}_{t} = \frac{1}{N} {\sum }_{i = 1}^{n} {X}_{t}^{{i}^{′}} ‖ {max}_{i = 1}^{n} {X}_{t}^{{i}^{′}}$$

where sₜ represents the global state of the system at the moment t,

$${X}_{t}^{{i}^{′}}$$

represents the weighted feature node of the graph, N represents the count of nodes, max represents the aggregation function, and i and n are positive integers.

Specifically, the steps of obtaining the fusion information and the adjacency trajectory matrix at the next time step through the encoder based on the dynamic directed graph are as follows: obtaining the input information through the communication part of the network module, including the local observation value of the UAV, the historical information, and the adjacency trajectory matrix Aₜ at the current moment; embedding and repeating the input information to convert it into a continuous vector; inputting the processed data into the multi-key gated unit, and controlling transmission of the information by multiple keys; updating the adjacency matrix Aₜ₊₁ through graph processing based on the output of the multi-key gated unit to represent the graph structure at the next time step; using the adjacency trajectory matrix Aₜ₊₁ and the repeated information as the fusion information and inputting together with the embedded information into the Transformer-based decoder.

Specifically, based on a value decomposition algorithm, the relationship between the local action value function and the global action value function is shown in formula (6):

$$arg {max}_{a} {Q}_{tot} ( τ , a ) = ( \begin{matrix}arg {max}_{{a}^{1}} {Q}^{1} ( {τ}^{1} , {a}^{1} ) \\ ⋮ \\ arg {max}_{{a}^{n}} {Q}^{n} ( {τ}^{n} , {a}^{n} )\end{matrix} )$$

where Qₜₒₜ(τ, a) represents the global action value function, τ represents the historical local observation value, a represents an action, argmax represents finding a maximum value point, and Qⁱ represents the local action value function of the UAV i.

Specifically, the steps of generating the local action value function and the hidden information through the Transformer-based decoder are as follows: obtaining the fusion information from the encoder based on the dynamic directed graph; processing the input information through a multi-head attention mechanism, residual connection and normalization, a point-by-point feedforward neural network, residual connection and normalization; adding the processed information to the embedded information output by the encoder, obtaining the hidden information through a fully connected layer, and obtaining the local action value function Qⁱ(s, a) of the UAV i by learning a Qⁱ(τ, a, Am, s) network.

Specifically, the steps of obtaining the global action value function through the graph collapse network and the mixing network are as follows: obtaining the input information through the communication part of the network module, including the local observation value, the adjacency matrix Aₜ₊₁ at the next time step, and the local action value function of the UAV; normalizing the adjacency matrix Aₜ₊₁, and obtaining the communication structure of the node at the current time step by combining the adjacency trajectory matrix and the local observations value; the local observation value is input into the graph convolutional network; performing three graph convolution iterations; performing self-attention pooling based on the information after iteration; aggregating the pooled information through the readout mechanism to generate the approximate global state of the system; inputting the global state and the local action value function into the mixing network, and the UAV swarm learning the mixing network Qₜₒₜ(τ, a, Am, s; θ) using a QMIX network based on the global state to determine a weight of the local action value function, and weighting and synthesizing the local action value function of each UAV into the global action value function Qₜₒₜ(s, a).

Specifically, a parameter θ of the mixing network Qₜₒₜ is updated using a loss function shown in formula (7):

$${ℒ}_{1} = {\sum }_{i = 1}^{b} [ {( {y}_{i}^{tot} - {Q}_{tot} ( {τ}_{t} , {α}_{t} , {m}_{t} , {s}_{t} ; θ ) )}^{2} ]$$

$${y}_{i}^{tot} = r + γ {max}_{{a}_{t + 1}} {Q}_{tot} ( {τ}_{t + 1} , {α}_{t + 1} , {m}_{t + 1} , {s}_{t + 1} ; {θ}^{-} )$$

where, [symbol] ₁ represents the first loss function, b represents a batch size sampled from a replay buffer,

$${y}_{i}^{tot}$$

represents a target Q value of the UAV i, Qₜₒₜ(τₜ, αₜ, mₜ, sₜ; θ) represents a mixing network Q value at the moment t, τₜ represents a historical observation value at the moment t, αₜ, represents an action at the moment t, mₜ represents the information of the UAV swarm at the moment t, sₜ represents the global state at the moment t, θ represents the parameter of the mixing network, r represents a reward obtained by the UAV swarm interacting with the environment, γ represents a discount factor, and max_{α}_{ₜ₊₁} represents a maximum Qₜₒₜ value of an action αₜ₊₁.

Specifically, in the present disclosure, the information transmitted by the UAV is the local observation value, and the relationship between the local observation value and the global state is shown in formula (8):

$${s}_{t} = σ ( W [ Agg [ {o}_{t}^{j} , ∀ {v}^{j} ∈ N ( {v}^{i} ) ] ‖ {o}_{t}^{i} ] )$$

where sₜ represents the global state of the system at the moment t,

$${o}_{t}^{i}$$

represents the local observation of a UAV j at the moment t, Agg represents aggregation, v represents a vertex, N(vⁱ) represents a set of neighboring points of node i, σ and W represent parameters of the feedforward neural network, i and j are positive integers.

Specifically, the global state value function Qₜₒₜ(s, a) is a function of a state vector s and a joint action a. According to the implicit function theorem, Qₜₒₜ can also be regarded as a function of the local action value function Qₜₒₜ(s, Qⁱ), and the expression of the global action value function can be obtained as shown in formula (9):

$${Q}_{tot} = σ ( ( W [ Agg [ {o}^{j} , ∀ {v}^{j} ∈ N ( {v}^{i} ) ] ‖ {o}^{i} ] ) , {Q}^{i} )$$

where, sₜ represents the global state of the system at the moment t,

$${o}_{t}^{i}$$

represents the local observation of the UAV j at the moment t, Agg represents aggregation, v represents the vertex, N(vⁱ) represents the set of neighboring points of node i, σ and W represent the parameters of the feedforward neural network, Qⁱ represents the local action value function of the i-th UAV, i and j are positive integers.

Specifically, the parameters of the graph collapse network are updated through the process described in formula (10):

$$W := W - α \cdot \frac{\partial {ℒ}_{1}}{\partial W} ,$$

$$b := b - α \cdot \frac{\partial {ℒ}_{1}}{\partial b}$$

where [symbol] ₁ represents the first loss function, W represents a weight, b represents a bias, and α represents a learning rate.

### Embodiment 2

The parts not mentioned in Embodiment 2 are the same as those in Embodiment 1.

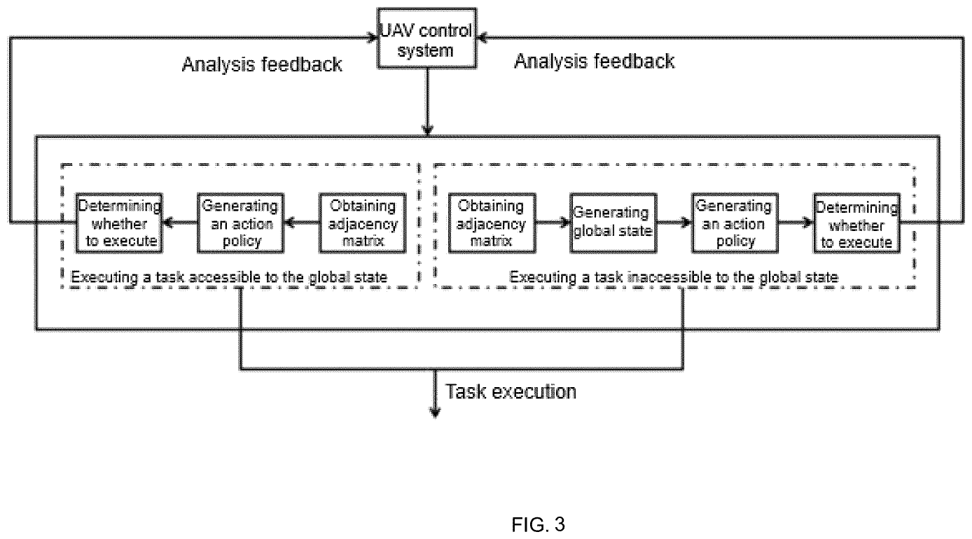

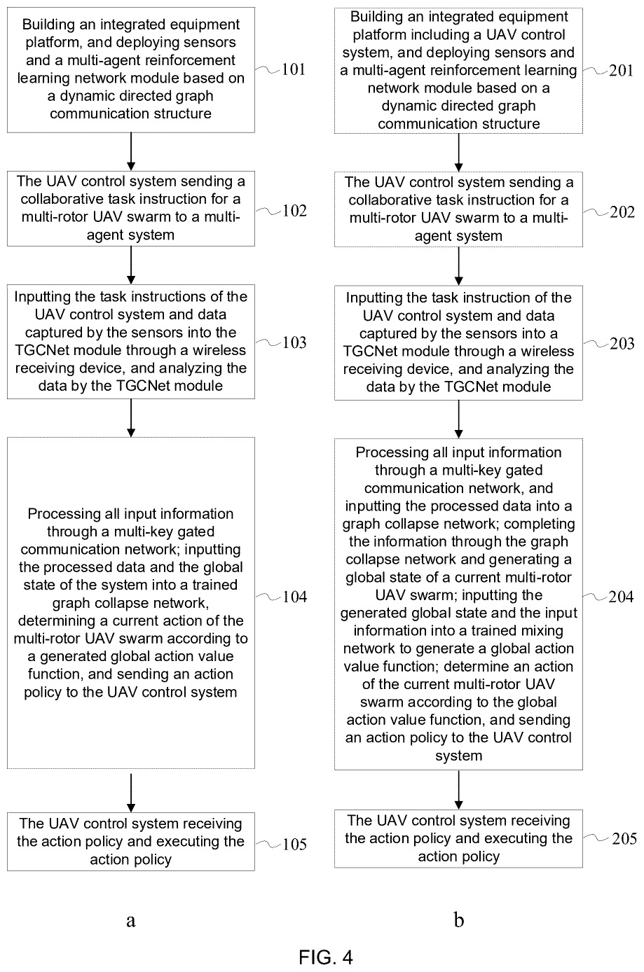

As shown in FIG. 3 and FIG. 4, a multi-rotor UAV is a highly stable and highly scalable six-rotor industrial UAV with a full carbon fiber fuselage. Embodiment 2 will use the multi-rotor UAV as the intelligent agent and implement it based on the technical solution of the present disclosure.

The multi-UAV reinforcement learning module based on the dynamic directed graph communication structure will distinguish between two task execution situations for the multi-rotor UAV according to different execution policies, providing support for full-process logical analysis and diagnosis, as follows:

Case 1: the multi-rotor UAV needs to perform a task accessible to the global state.

Case 2: the multi-rotor drone needs to perform a task inaccessible to the global state.

As shown in FIG. 4, portion a is a flowchart showing a multi-rotor UAV performing a task accessible to the global state, and portion b is a flowchart showing a multi-rotor UAV performing a task inaccessible to the global state. When the multi-rotor UAV faces case 1, the specific steps for performing the relevant task through a TGCNet module and a multi-agent reinforcement learning method include:
Step S101: building an integrated equipment platform including a UAV control system, and deploying sensors and a multi-agent reinforcement learning network module based on a dynamic directed graph communication structure;
Step S102: the UAV control system sending a collaborative task instruction for a multi-rotor UAV swarm to a multi-agent system;
Step S103: inputting the collaborative task instruction of the UAV control system and data captured by the sensors into the TGCNet module through a wireless receiving device, and analyzing the data by the TGCNet module;
Step S104: processing all input information through a multi-key gated communication network; inputting the processed data and the global state of the system into a trained graph collapse network, determining a current action of the multi-rotor UAV swarm according to a generated global action value function, and sending an action policy to the UAV control system;
Step S105: the UAV control system receiving the action policy sent by the TGCNet module and evaluating and analyzing the action policy, if the current action of the multi-rotor UAV swarm satisfies a task instruction requirement issued by the UAV control system, the multi-rotor UAV swarm being allowed to execute the current action by default; if the current action of the multi-rotor UAV swarm does not satisfy the task instruction requirement issued by the UAV control system, the UAV control system sending an instruction to stop the current action of the multi-rotor UAV swarm and requiring the integrated module to collect all data again and repeating steps S3-S5 until the action of the multi-rotor UAV swarm satisfies the task instruction requirement issued by the UAV swarm control system, and then stopping the process.

When the multi-rotor UAV faces case 2, the specific steps for performing the relevant task through the TGCNet module and the multi-agent reinforcement learning method include:
Step S201: building an integrated equipment platform including a UAV control system, and deploying sensors and a multi-agent reinforcement learning network module based on a dynamic directed graph communication structure;
Step S202: the UAV control system sending a collaborative task instruction for a multi-rotor UAV swarm to a multi-agent system;
Step S203: inputting the collaborative task instruction of the UAV control system and data captured by the sensors into a TGCNet module through a wireless receiving device, and analyzing the data by the TGCNet module;
Step S204: processing all input information through a multi-key gated communication network, and inputting the processed data into a graph collapse network; completing the information through the graph collapse network and generating a global state of a current multi-rotor UAV swarm; inputting the generated global state and the input information into a trained mixing network to generate a global action value function; determine an action of the current multi-rotor UAV swarm according to the global action value function, and sending an action policy to the UAV control system;
Step S205: the UAV control system receiving the action policy by the TGCNet module and evaluating and analyzing the action policy, if the execution action of the current multi-rotor UAV swarm satisfies a task instruction requirement issued by the UAV control system, the multi-rotor UAV swarm is allowed to execute the current action by default, if the execution action of the current multi-rotor UAV swarm does not satisfy the task instruction requirement issued by the UAV control system, the UAV control system sending an instruction to stop the action of the current multi-rotor UAV swarm and requiring the integrated module to collect all data again and repeating steps S3-S5 until the execution action of the multi-rotor UAV swarm satisfies the task instruction requirement issued by the UAV swarm control system, and then stopping the process.

If the above solutions are implemented as software functional units and sold or used as independent products, they can be stored in a computer-readable storage medium. Based on this understanding, the technical solution of the present disclosure, or the part that contributes to the existing technologies, or part of the technical solution, can be embodied in the form of a software product. This computer software product is stored in a storage medium and includes several instructions to cause a computer device (which may be a personal computer, a server, or a network device, etc.) to execute all or part of the steps of the methods described in various embodiments of the present disclosure. The storage medium includes: USB flash drives, mobile hard drives, read-only memory (ROM), random access memory (RAM), magnetic disks, optical disks, and other media capable of storing program codes.

The above description is merely a specific embodiment of the present disclosure, but the scope of the present disclosure is not limited thereto. Any person skilled in the art can easily conceive of various equivalent modifications or substitutions within the technical scope disclosed in the present disclosure, and these modifications or substitutions should all be covered within the scope of the present disclosure.

1. A multi-UAV coordinated control method based on a dynamic directed graph communication structure, comprising:
obtaining, by UAVs, local observation values of an environment and obtaining historical hidden states from other UAVs through communication;
in a distributed execution phase, obtaining a current adjacency trajectory matrix representing a communication relationship between UAVs at a current moment based on an initial topology of the UAVs, calculating pre-communication information based on the local observation values and the historical hidden states, inputting the current adjacency trajectory matrix and the pre-communication information into a multi-key gated communication network to calculate an adjacency trajectory matrix at a next moment, each UAV calculating its local action value function based on the pre-communication information and the adjacency trajectory matrix at the next moment through a Transformer-based decoder and updating its hidden state, generating and executing a final control decision based on the local action value function and the local observation value through a graph collapse network and a mixing network, and then proceeding to a next loop;
in a centralized training phase, recording the adjacency trajectory matrix at each moment of the distributed execution phase, inputting the local observation value and the adjacency trajectory matrix at each moment into the graph collapse network to generate a global state at each moment, generating a global action value function at each moment based on the global state at each moment and the local action value function of each UAV at each moment, a UAV swarm interacting with the environment and obtaining rewards based on the global action value function, and updating parameters of the mixing network based on the rewards through a first loss function; and
after centralized training is completed, deploying a trained graph collapse network and the mixing network to each UAV.

2. The multi-UAV coordinated control method according to claim 1, wherein the adjacency trajectory matrix represents a multi-UAV communication structure, the adjacency trajectory matrix is a Boolean matrix, and a value of a matrix element indicates whether there is communication between the UAVs.

3. The multi-UAV coordinated control method according to claim 1, wherein the calculating pre-communication information based on the local observation values and the historical hidden states comprises:
converting the local observation values and the historical hidden states into pre-communication information C₀ using an encoding network MLP:
$${C}_{0} = MLP ( {o}_{t}^{i} , {h}_{t - 1}^{i} )$$
where C₀ represents the pre-communication information,
$${O}_{t}^{i}$$
represents the local observation values, and
$${h}_{t - 1}^{i}$$
represents the historical hidden states.

4. The multi-UAV coordinated control method according to claim 1, wherein the inputting the current adjacency trajectory matrix and the pre-communication information into a multi-key gated communication network to calculate an adjacency trajectory matrix at a next moment comprises:
inputting a current adjacency trajectory matrix Aₜ and pre-communication information C₀ into the multi-key gated communication network for processing, wherein a calculation formula for the multi-key gated communication network is as follows:
$${K}_{0} = gumbel - softmax ( {w}_{v}^{T} tanh ( {W}_{q} ( {A}_{0} \times {C}_{0} ) + {W}_{k} ( {A}_{0} \times {C}_{0} ) ) )$$
where K₀ is a key output, A₀ represents an updated adjacency trajectory matrix in this communication; gumbel-softmax is a discrete sampling technique used to sample from discrete communication structures to determine whether each pair of UAVs communicates; Wᵥ represents a linear layer weight of an output dimension used to generate a final communication determination; tanh represents an activation function; C₀ represents the pre-communication information; W_{q} represents a query weight; and Wₖ represents a key weight;
after processing through the multi-key gated communication network, obtaining a total of i keys at a moment t, denoted as k_{t|i}, wherein the adjacency trajectory matrix at the next moment is represented as:
$${A}_{t + 1} = ⌈ {max}_{i} {k}_{t \vert i} ⌉$$
where [⋅] represents rounding up, and Aₜ₊₁ represents the adjacent trajectory matrix at the next moment.

5. The multi-UAV coordinated control method according to claim 1, wherein the each UAV calculating its local action value function based on the pre-communication information and the adjacency trajectory matrix at the next moment through a Transformer-based decoder and updating its hidden state comprises:
repeatedly processing the pre-communication information by a multilayer perceptron (MLP) and then inputting into the Transformer-based decoder with the adjacency trajectory matrix at the next moment, the Transformer-based decoder comprising a self-attention mechanism, a position feedforward network, residual connection, and a normalization layer, input information being processed by a multi-head attention mechanism, residual connection and normalization, a point-by-point feedforward neural network, and residual connection and normalization, and adding processed information to the pre-communication information to obtain an updated hidden state
$${h}_{t}^{i}$$
and a local action value function Qⁱ(s, a) of a UAV i through a fully connected layer.

6. The multi-UAV coordinated control method according to claim 1, wherein the graph collapse network comprises a graph convolutional network, a self-attention pooling network, and a readout mechanism.

7. The multi-UAV coordinated control method according to claim 1, wherein the generating a global state comprises:
using the local observation value
$${O}_{t}^{i}$$
of each UAV as a feature input to each node in the graph convolutional network for feature extraction and node learning representation, as shown in the formula:
$${\tilde{X}}_{t}^{i} = σ ( {\tilde{D}}_{t + 1}^{{i}^{- \frac{1}{2}}} {A}_{t + 1}^{i} {\tilde{D}}_{t + 1}^{{i}^{- \frac{1}{2}}} {o}_{t}^{i} )$$
where
$${O}_{t}^{i}$$
represents the local observation value of the UAV i at the moment t,
$${\tilde{X}}_{t}^{i}$$
represents node representation,
$${A}_{t + 1}^{i}$$
represents a value or an i-th node in the adjacency trajectory matrix at the next moment,
$${\tilde{D}}_{t + 1}^{i}$$
represents a degree matrix of the i-th UAV at a moment t+1, and σ represents a nonlinear activation function;
inputting learned node representation
$${\tilde{X}}_{t}^{i}$$
into the self-attention pooling network, the self-attention pooling network selecting important nodes in the graph through feature weighting and node importance evaluation, and then weighting features of the important nodes to output feature weighted nodes of the graph, as shown in the formula:
$${X}_{t}^{{i}^{′}} = concat ( {\tilde{X}}_{i}^{i} ) ⊙ tanh ( {\tilde{D}}_{t + 1}^{{i}^{- \frac{1}{2}}} {A}_{t + 1}^{i} {\tilde{D}}_{t + 1}^{{i}^{- \frac{1}{2}}} concat ( {\tilde{X}}_{t}^{i} ) )$$
where
$${X}_{t}^{{i}^{′}}$$
represents weighted feature node representation of a node i, concat represents a feature fusion method, tanh represents an activation function, and ⊙ represents element-wise multiplication;
aggregating the weighted feature node representation of each node through a readout mechanism to generate a global state st, as shown in the formula:
$${s}_{t} = \frac{1}{N} {\sum }_{i = 1}^{n} {X}_{t}^{{i}^{′}} ‖ \begin{matrix}n \\ max \\ i = 1\end{matrix} {X}_{t}^{{i}^{′}}$$
where N represents a count of nodes, max represents an aggregation function, and i and n represent positive integers.

8. The multi-UAV coordinated control method according to claim 1, wherein the generating a global action value function at each moment based on the global state at each moment and the local action value function of each UAV at each moment comprises:
inputting a global state st and a local action value function Qⁱ(s, a) of each UAV into the mixing network, a UAV swarm learning a mixing network Qₜₒₜ(τ, α, Am, s; θ) and using a QMIX network to determine a weight of each local action value function using the global state, and then weighting the local action value function of each UAV to synthesize a global action value function Qₜₒₜ(s, a).

9. The multi-UAV coordinated control method according to claim 1, wherein the first loss function is represented as:
$${ℒ}_{1} = {\sum }_{i = 1}^{b} [ {( {y}_{i}^{tot} - {Q}_{tot} ( {τ}_{t} , {α}_{t} , {m}_{t} , {s}_{t} ; θ ) )}^{2} ]$$
$${y}_{i}^{tot} = r + γ {max}_{{a}_{t + 1}} {Q}_{tot} ( {τ}_{t + 1} , {α}_{t + 1} , {m}_{t + 1} , {s}_{t + 1} ; {θ}^{-} )$$
where [symbol] ₁ represents the first loss function, b is a batch size, representing a count of samples sampled from a replay buffer,
$${y}_{i}^{tot}$$
represents a target Q value of the UAV i, Qₜₒₜ(τₜ, αₜ, mₜ, sₜ; θ) represents a mixing network Q value at a moment t, τₜ represents a historical observation value at the moment t, αₜ represents an action at the moment t, mₜ represents information of the UAV swarm at the moment t, sₜ represents the global state at the moment t, θ represents a parameter of the mixing network, r represents a reward obtained by the UAV swarm interacting with the environment, γ represents a discount factor, and max_{α}_{ₜ₊₁} represents a maximum Qₜₒₜ value of an action αₜ₊₁.

10. The multi-UAV coordinated control method according to claim 1, wherein the distributed execution phase and the centralized training phase are bridged through the adjacency trajectory matrix.
